(19) United States
(12) Patent Application Publication
(10) Pub. No.: US 2022/0411622 A1
(43) Pub. Date: Dec. 29, 2022

(54) RESIN COMPOSITION, PLATE-SHAPED MOLDED ARTICLE, MULTILAYERED ARTICLE, AND ANTI-REFLECTION FILM

(71) Applicant: MITSUBISHI GAS CHEMICAL COMPANY, INC., Tokyo (JP)

(72) Inventors: Keisuke TOMITA, Tokyo (JP); Kaori SAKURAI, Tokyo (JP)

(73) Assignee: MITSUBISHI GAS CHEMICAL COMPANY, INC., Tokyo (JP)

(21) Appl. No.: 17/774,626

(22) PCT Filed: Nov. 16, 2020
(86) PCT No.: PCT/JP2020/042635

§ 371 Date: May 5, 2022

(30) Foreign Application Priority Data
Nov. 18, 2019 (JP) 2019-207852

(51) Int. Cl. C08L 33/12; C08F 212/08; C08F 220/06; C08F 220/18; B32B 27/30; C08J 5/18

(52) U.S. Cl. CPC C08L 33/12; C08F 212/08; C08F 220/06; C08F 220/1806; B32B 27/308; C08J 5/18; C08L 2201/10; C08L 2203/16; C08L 2205/025; C08L 2205/035; B32B 2250/04; B32B 2307/536; B32B 2307/412; B32B 2333/12

(57) ABSTRACT

Provided is a resin composition capable of providing a plate-shaped molded article having a high refractive index as well as a high hardness, and a plate-shaped molded article, a multilayered article, and an anti-reflection film formed from the resin composition. The resin composition contains 10 to 99 parts by mass of an acrylic resin (A); and 90 to 1 part by mass of a random copolymer (B) derived from a monomer composition B composed of 5 to 95 mass % of a (meth)acrylate represented by the formula (b1) (b-1), 5 to 95 mass % of an aromatic (meth)acrylate (b-2), and 0 to 20 mass % of an additional monomer (b-3); in the formula (b1), Rb¹ is a hydrogen atom or a methyl group, and Rb² is an aliphatic group.

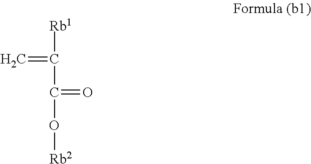

### TECHNICAL FIELD

The present invention relates to a resin composition, a plate-shaped molded article, a multilayered article, and an anti-reflection film.

### BACKGROUND ART

Acrylic resins, which have excellent transparency and formability and have excellent surface hardness, have been used as optical materials in many applications. On the other hand, acrylic resins have poor material toughness. Thus, a method is known in which an acrylic resin is coextruded with a polycarbonate resin to produce a multilayered film or sheet excellent in transparency and material toughness (Patent Literature 1).

However, a large difference in refractive index between the acrylic resin and the polycarbonate resin may cause a defect called “iridescent irregularities” when such films or sheets are used in optical components and the like.

### CITATION LIST

### Patent Literature

### [Patent Literature 1]

Japanese Patent Laid-Open No. 55-059929

### SUMMARY OF INVENTION

### Technical Problem

For the purpose of solving the above problem, the present invention aims to provide a resin composition from which a plate-shaped molded article, as a layer including an acrylic resin, can be formed, the resin composition being capable of providing a plate-shaped molded article having high refractive index as well as high hardness, and a plate-shaped molded article, a multilayered article, and an anti-reflection film formed from the resin composition.

### Solution to Problem

Under the above problem, the present inventors have found that the above problem may be solved by using a predetermined acrylic resin blend as the resin composition including an acrylic resin.

Specifically, the above problem has been solved by the following measures.

<1> A resin composition comprising 10 to 99 parts by mass of an acrylic resin (A), and 90 to 1 part by mass of a random copolymer (B) derived from a monomer composition B composed of 5 to 95 mass % of a (meth)acrylate represented by the formula (b1) (b-1), 5 to 95 mass % of an aromatic (meth)acrylate (b-2), and 0 to 20 mass % of an additional monomer (b-3):

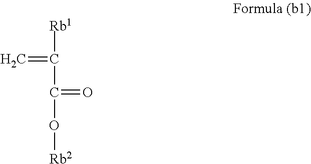

wherein Rb¹ is a hydrogen atom or a methyl group, and Rb² is an aliphatic group.

<2> The resin composition according to <1>, wherein the acrylic resin (A) comprises an acrylic resin derived from a monomer composition A1 composed of more than 90 mass % of a (meth)acrylate represented by the formula (a1) (a-1) and 0 mass % or more and less than 10 mass % of an additional monomer (a-11):

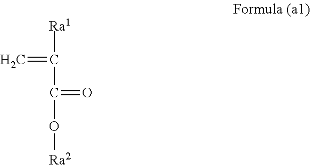

wherein Ra¹ is a hydrogen atom or a methyl group, and Ra² is an aliphatic group.

<3> The resin composition according to <1> or <2>, wherein the acrylic resin (A) comprises an acrylic resin derived from a monomer composition A2 composed of 5 to 95 mass % of a (meth)acrylate represented by the formula (a1) (a-1), 5 to 95 mass % of an aromatic vinyl compound (a-2), and 0 to 20 mass % of an additional monomer (a-3):

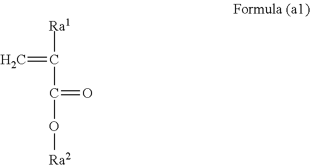

wherein Ra¹ is a hydrogen atom or a methyl group, and Ra² is an aliphatic group.

<4> The resin composition according to any one of <1> to <3>, wherein the (meth)acrylate represented by the formula (b1) (b-1) comprises an alkyl methacrylate.
<5> The resin composition according to any one of <1> to <4>, wherein the aromatic (meth)acrylate (b-2) comprises an aromatic methacrylate.
<6> The resin composition according to any one of <1> to <5>, wherein the aromatic (meth)acrylate (b-2) comprises a (meth)acrylate represented by the formula (b21):

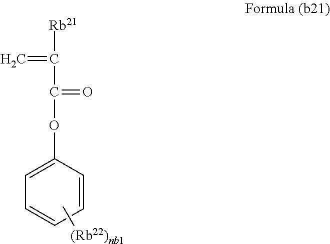

wherein Rb²¹ is a hydrogen atom or a methyl group, Rb²² is a substituent, and nb1 is an integer of 0 to 6.

<7> The resin composition according to any one of <1> to <6>, wherein the aromatic (meth)acrylate (b-2) comprises a (meth)acrylate represented by the formula (b22):

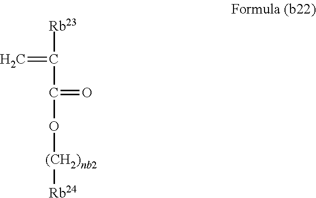

wherein Rb²³ is a hydrogen atom or a methyl group, Rb²⁴ is an aromatic ring-containing group, and nb2 is an integer of 1 to 4.

<8> The resin composition according to any one of <1> to <7>, wherein the aromatic (meth)acrylate (b-2) comprises a (meth)acrylate represented by the formula (b23):

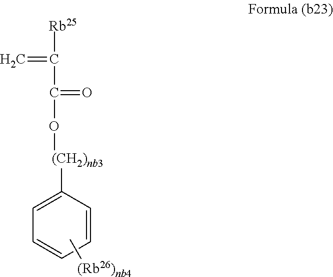

wherein Rb²⁵ is a hydrogen atom or a methyl group, nb3 is an integer of 1 to 4, Rb⁶ is a substituent, at least one of Rb²⁶ is an aryl group, and nb4 is an integer of 1 to 6.

<9> The resin composition according to any one of <1> to <8>, wherein a proportion of the (meth)acrylate represented by the formula (b1) (b-1) in the monomer composition B is 40 mass % or more and less than 85 mass %.
<10> The resin composition according to <9>, wherein the acrylic resin (A) comprises an acrylic resin derived from a monomer composition A1 composed of more than 90 mass % of a (meth)acrylate represented by the formula (a1) (a-1) and 0 mass % or more and less than 10 mass % of an additional monomer (a-11):

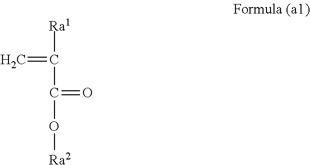

wherein Ra¹ is a hydrogen atom or a methyl group, and Ra² is an aliphatic group.

<11> The resin composition according to <9>, wherein the acrylic resin (A) comprises an acrylic resin derived from a monomer composition A2 composed of 5 to 95 mass % of a (meth)acrylate represented by the formula (a1) (a-1), 15 to 95 mass % of an aromatic vinyl compound (a-2), and 0 to 20 mass % of an additional monomer (a-3).
<12> The resin composition according to any one of <1> to <9>, wherein the acrylic resin (A) comprises an acrylic resin derived from a monomer composition A3 composed of methyl methacrylate at a proportion of 95 mass % or more.
<13> The resin composition according to any one of <1> to <9>, wherein the acrylic resin (A) comprises a random copolymer derived from a monomer composition A4 composed of methyl methacrylate and methacrylic acid.
<14> The resin composition according to any one of <1> to <13>, further comprising 0.001 to 0.5 parts by mass of an antioxidant (D) based on 100 parts by mass of the resin composition.
<15> The resin composition according to any one of <1> to <14>, further comprising 0.001 to 0.5 parts by mass of a mold release agent (E) based on 100 parts by mass of the resin composition.
<16> A plate-shaped molded article formed from the resin composition according to any one of <1> to <15>.
<17> The plate-shaped molded article according to <16>, having a thickness of 5 to 10,000 μm.
<18> A multilayered article comprising a base material and the plate-shaped molded article according to <16> or <17>.
<19> The multilayered article according to <18>, wherein the base material comprises a polycarbonate resin.
<20> The multilayered article according to <18> or <19>, further comprising a hard coat layer on the plate-shaped molded article and/or the base material.
<21> The multilayered article according to <20>, further comprising an anti-reflection layer on the hard coat layer.
<22> The multilayered article according to any one of <18> to <21>, wherein any one or more of anti-fingerprint treatment, anti-glare treatment, weather resistant treatment, antistatic treatment, anti-fouling treatment, and anti-blocking treatment are further applied on at least one surface of the multilayered article.
<23> An anti-reflection film comprising the multilayered article according to any one of <18> to <22>.

### Advantageous Effects of Invention

According to the present invention, it is now possible to provide a resin composition from which a plate-shaped molded article, as a layer including an acrylic resin, can be formed, the resin composition being capable of providing a plate-shaped molded article having a high refractive index as well as a high hardness, and a plate-shaped molded article, a multilayered article, and an anti-reflection film formed from the resin composition.

### BRIEF DESCRIPTION OF DRAWING

FIG. 1 is a schematic view illustrating the configuration of an exemplary anti-reflection film.

### DESCRIPTION OF EMBODIMENTS

Hereinafter, the content of the present invention will be described in detail. The notation “to” between two numerical values as used herein means that the numerical values are included as the lower limit or upper limit.

Various physical property values and characteristic values herein are intended to be at 23° C., unless otherwise described.

Regarding the notation of “group (atomic group)” herein, the notation with no indication of “substituted” or “unsubstituted” includes both “group (atomic group) having no substituent” and “group (atomic group) having a substituent”. In the present invention, each group preferably has no substituent, unless otherwise specified. For example, an “alkyl group” includes not only an alkyl group having no substituent (unsubstituted alkyl group) but also an alkyl group having a substituent (substituted alkyl group).

Herein, “(meth)acrylate” represents both or either of acrylate and methacrylate.

A plate-shaped molded article and a multilayered article herein each are meant to include a body in a film shape and a body in a sheet shape. A “film” and a “sheet” each refer to a substantially flat molded article having a thin thickness with respect to the length and the width. The “film” herein may be a single layer or a multilayer.

Herein the expression “parts by mass” represents the relative amount of a component, and the expression “mass %” represents the absolute amount of a component.

The resin composition of the present invention includes 10 to 99 parts by mass of an acrylic resin (A), and 90 to 1 part by mass of a random copolymer (B) derived from a monomer composition B composed of 5 to 95 mass % of a (meth)acrylate represented by the formula (b1) (b-1), 5 to 95 mass % of an aromatic (meth)acrylate (b-2), and 0 to 20 mass % of an additional monomer (b-3):

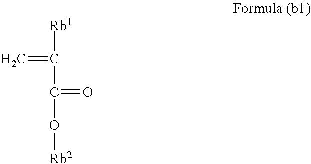

wherein Rb¹ is a hydrogen atom or a methyl group, and Rb² is an aliphatic group.

Such a configuration enables to provide a resin composition capable of providing a plate-shaped molded article having a high refractive index as well as a high hardness. The configuration can also enhance the total light transmittance of the plate-shaped molded article.

### <Acrylic Resin (A)>

The resin composition of the present invention includes an acrylic resin (A). The acrylic resin (A) here is meant not to include a random copolymer (B) described below. Incorporation of the acrylic resin (A) enables to provide a resin composition excellent in toughness and pencil hardness. The acrylic resin (A) refers to a resin including more than 5 mass % (preferably more than 30 mass %, more preferably more than 50 mass %) of a (meth)acrylate (a monomer having a (meth)acryloyloxy group) with respect to the raw material monomers constituting the acrylic resin (A). In the present invention, the (meth)acrylate is preferably a methacrylate.

The weight average molecular weight of the acrylic resin (A) is preferably 10,000 or more, more preferably 30,000 or more, still more preferably 50,000 or more. The weight average molecular weight of the acrylic resin (A) is also preferably 500,000 or less, more preferably 300,000 or less, still more preferably 200,000 or less. When two or more acrylic resins (A) are included, the weight average molecular weight is regarded as the weight average molecular weight of the mixture.

As the acrylic resin (A), known acrylic resins can be broadly employed. For example, the description in the paragraphs 0011 to 0024 of Japanese Patent Laid-Open No. 2019-131667 and the description in the paragraphs 0023 to 0029 of Japanese Patent Laid-Open No. 2018-076459 can be referred to, and the contents thereof are incorporated herein.

A first embodiment of the acrylic resin (A) in the present invention is an acrylic resin derived from a monomer composition A1 composed of more than 90 mass % of a (meth)acrylate represented by the formula (a1) (a-1) and 0 mass % or more and less than 10 mass % of an additional monomer (a-11). Use of the acrylic resin (A) enables to provide a resin composition exhibiting a high hardness.

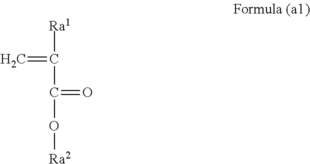

wherein Ra¹ is a hydrogen atom or a methyl group, and Ra² is an aliphatic group.

In the first embodiment of the acrylic resin (A), the raw material monomers of the monomer composition A1 are composed of more than 90 mass % of a (meth)acrylate (a-1) and 0 mass % or more and less than 10 mass % of an additional monomer (a-11). Here, the expression “composed of” means that monomers constituting substantially all the constituent units excluding both ends are the (meth)acrylate (a-1) or the additional monomer (a-11). The expression “substantially all the constituent units excluding both ends” herein means 99.0 mol % or more, preferably 99.5 mol % or more, more preferably 99.9 mol % or more of all the constituent units excluding both ends. Examples of the end groups include groups derived from a chain transfer agent.

The content of the (meth)acrylate (a-1) in the monomer composition A1 is preferably 92 mass % or more, more preferably 94 mass % or more, still more preferably 95 mass % or more, may be 97 mass % or more, may be 99 mass % or more, and may be 100 mass %. The upper limit of the content of the (meth)acrylate (a-1) is preferably 100 mass % or less.

The upper limit of the content of the additional monomer (a-11) in the monomer composition A1 is preferably 8 mass % or less, more preferably 6 mass % or less, still more preferably 5 mass % or less, may be 3 mass % or less, and may be 1 mass % or less.

The monomer composition A1 may include one type of each of the (meth)acrylate (a-1) and the additional monomer (a-11) or may include two types or more of each of them. When two types or more thereof are included, the total amount preferably falls within the range described above.

Next, each of the monomers constituting the monomer composition A1 will be described.

First, the details of the (meth)acrylate represented by the formula (a1) (a-1) will be described.

In the above formula (a1), Ra¹ is a hydrogen atom or a methyl group, preferably a methyl group. Ra² is an aliphatic group, preferably a linear or branched aliphatic group, more preferably a linear aliphatic group. Examples of the aliphatic group include an alkyl group (including a cycloalkyl group), an alkynyl group (including a cycloalkynyl group), and an alkenyl group (including a cycloalkenyl group). The aliphatic group is preferably an alkyl group, more preferably a linear or branched alkyl group, still more preferably a linear alkyl group. The aliphatic group as Ra² has preferably 1 to 10 carbon atoms, more preferably 1 to 5 carbon atoms, still more preferably 1 to 3 carbon atoms, further preferably 1 or 2 carbon atoms, still further preferably 1 carbon atom.

The (meth)acrylate represented by the formula (a1) is preferably an alkyl (meth)acrylate (preferably an alkyl methacrylate), more preferably methyl (meth)acrylate (preferably methyl methacrylate).

Next, the additional monomer (a-11) will be described. The additional monomer (a-11) is a monomer other than the (meth)acrylate represented by the formula (a1), and monomers known as raw material monomers for the acrylic resin may be broadly employed. Specific examples thereof include a (meth)acrylic acid, an aromatic (meth)acrylate (preferably one in which a substituted or unsubstituted aromatic ring group has a (meth)acryloyloxy group attached thereto), an alkoxy (meth)acrylate, an aryloxy (meth)acrylate, and a vinyl compound. Specific examples include (meth)acrylic acid, benzyl (meth)acrylate, phenyl (meth)acrylate, methoxyethyl (meth)acrylate, ethoxyethyl (meth)acrylate, 2-naphthyl (meth)acrylate, phenoxymethyl (meth)acrylate, and styrene. (Meth)acrylic acid is preferred, and methacrylic acid is more preferred.

Next, a preferred embodiment of the monomer composition A1 will be described.

An example of the preferred embodiment of the monomer composition A1 is an aspect of a monomer composition A3 including methyl methacrylate at a proportion of 95 mass % or more.

In a first embodiment of the monomer composition A1 (monomer composition A3), the upper limit of the content of methyl methacrylate is preferably 100 mass % or less, preferably 99 mass % or less, more preferably 98 mass % or less.

In the monomer composition A3, the additional monomer other than methyl methacrylate has the same meaning as that of the aforementioned additional monomer (a-11) and is preferably methyl acrylate.

A more preferred example of the monomer composition A3 includes a monomer composition A3′ composed of 95 to 99 mass % of methyl methacrylate and 5 to 1 mass % of methyl acrylate.

In the monomer composition A3, the monomers constituting substantially all the constituent units excluding both ends preferably are the methyl methacrylate or the additional monomer (a-11) (preferably methyl acrylate). The expression “substantially all the constituent units excluding both ends” herein means 99.0 mol % or more, preferably 99.5 mol % or more, more preferably 99.9 mol % or more of all the constituent units excluding both ends.

Another example of a preferred embodiment of the monomer composition A1 is a monomer composition A4. In other words, the monomer composition A1 is also more preferably a monomer composition A4 including methyl methacrylate and methacrylic acid. The acrylic resin derived from the monomer composition A4 is preferably a random copolymer. When the acrylic resin is a random copolymer, the compatibility with the random copolymer (B) tends to further increase.

In the monomer composition A4, the content of methyl methacrylate is preferably 90 mass % or more, more preferably 92 mass % or more, still more preferably 94 mass % or more. The content of methacrylic acid is preferably 1 mass % or more, more preferably 3 mass % or more, still more preferably 4 mass % or more. The total content of methyl methacrylate and methacrylic acid is preferably 95 mass % or more, more preferably 97 mass % or more, still more preferably 99 mass % or more, further preferably 100 mass %, with respect to the monomers included in the monomer composition A4.

In the monomer composition A4, the monomers constituting substantially all the constituent units excluding both ends preferably are the methyl methacrylate or methacrylic acid. The expression “substantially all the constituent units excluding both ends” herein means 99.0 mol % or more, preferably 99.5 mol % or more, more preferably 99.9 mol % or more of all the constituent units excluding both ends.

A second embodiment of the acrylic resin (A) in the present invention is an acrylic resin derived from a monomer composition A2 composed of 5 to 95 mass % of (meth)acrylate represented by the formula (a1) (a-1), 5 to 95 mass % of an aromatic vinyl compound (a-2), and 0 to 20 mass % of an additional monomer (a-3). Use of the acrylic resin (A) enables to provide a resin composition having a high refractive index.

In the second embodiment of the acrylic resin (A), the monomer composition A2 is composed of 5 to 95 mass % of (meth)acrylate (a-1), 5 to 95 mass % of an aromatic vinyl compound (a-2), and 0 to 20 mass % of an additional monomer (a-3). Here, the expression “composed of” means that the monomers constituting substantially all the constituent units excluding both ends are the (meth)acrylate (a-1), the aromatic vinyl compound (a-2), or the additional monomer (a-3). The expression “substantially all the constituent units excluding both ends” herein means 99.0 mol % or more, preferably 99.5 mol % or more, more preferably 99.9 mol % or more of all the constituent units excluding both ends.

The content of the (meth)acrylate (a-1) in the monomer composition A2 is preferably 20 mass % or more, more preferably 40 mass % or more, still more preferably 50 mass % or more, further preferably 60 mass % or more, still further preferably 70 mass % or more. The upper limit of the content of the (meth)acrylate (a-1) is preferably 90 mass % or less, more preferably 85 mass % or less, still more preferably 80 mass % or less.

The content of the aromatic vinyl compound (a-2) in the monomer composition A2 is preferably 10 mass % or more, more preferably 15 mass % or more, still more preferably 20 mass % or more. The upper limit of the content of the aromatic vinyl compound (a-2) is preferably 80 mass % or less, more preferably 60 mass % or less, still more preferably 50 mass % or less, further preferably 40 mass % or less, still further preferably 30 mass % or less.

The upper limit of the content of the additional monomer (a-3) in the monomer composition A2 is preferably 15 mass % or less, more preferably 10 mass % or less, still more preferably 5 mass % or less, further preferably 3 mass % or less, still further preferably 1 mass % or less.

The monomer composition A2 may include only one type of each of the (meth)acrylate (a-1), the aromatic vinyl compound (a-2), and the additional monomer (a-3) or may include two types or more of each of them. When two types or more thereof are included, the total amount preferably falls within the range described above.

Next, each of the monomers constituting the monomer composition A2 will be described.

First, the (meth)acrylate (a-1) has the same meaning as that of the (meth)acrylate (a-1) set forth in the description of the monomer composition (A1), and the preferred structure thereof is also the same.

Next, the aromatic vinyl compound (a-2) will be described.

The aromatic vinyl compound (a-2) is a compound having a vinyl group and an aromatic ring group, and compounds copolymerizable with (meth)acrylate may be broadly employed. The aromatic vinyl compound (a-2) is preferably a compound represented by CH₂═CH-L¹-Ar¹. Wherein L¹ is a single bond or a divalent linking group, preferably a single bond or a divalent linking group having a formula weight of 100 to 500, more preferably a single bond or a divalent linking group having a formula weight of 100 to 300. When L¹ is a divalent linking group, the group is preferably an aliphatic hydrocarbon group or a group constituted of a combination of an aliphatic hydrocarbon group and —O—. Here, the formula weight means the mass (g) per 1 mol of the portion corresponding to L¹ of the aromatic vinyl compound (a-2). Hereinafter, other “formula weights” are considered in the same manner. Ar¹ is an aromatic ring group, preferably a substituted or unsubstituted benzene ring group or naphthalene ring (preferably a benzene ring), more preferably an unsubstituted benzene ring group.

More specifically, the aromatic vinyl compound (a-2) preferably includes an aromatic vinyl compound represented by the formula (a2)

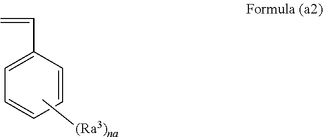

wherein Ra³ a substituent, and na is an integer of 0 to 6.

In the formula (a2), Ra³ is a substituent, and examples of the substituent include a halogen atom (preferably a chlorine atom, fluorine atom, or bromine atom), a hydroxy group, an alkyl group (preferably an alkyl group having 1 to 5 carbon atoms), an aryl group (preferably a phenyl group), an alkenyl group (preferably an alkenyl group having 2 to 5 carbon atoms), an alkoxy group (preferably an alkoxy group having 1 to 5 carbon atoms), and an aryloxy group (preferably a phenoxy group). When na is 2 or more, a plurality of Ra³ each may be the same or different.

na is preferably an integer of 5 or less, more preferably an integer of 4 or less, still more preferably an integer of 3 or less, further preferably an integer of 2 or less, still further preferably an integer of 1 or less, even further preferably 0.

The aromatic vinyl compound (a-2) is preferably a compound having a molecular weight of 104 to 600, more preferably a compound having a molecular weight of 104 to 400.

Specific examples of the aromatic vinyl compound (a-2) include styrene derivatives such as styrene, α-methylstyrene, o-methylstyrene, p-methylstyrene, vinylxylene, ethylstyrene, dimethylstyrene, p-tert-butylstyrene, vinylnaphthalene, methoxystyrene, monobromostyrene, dibromostyrene, fluorostyrene, and tribromostyrene, and styrene is particularly preferred.

Next, the additional monomer (a-3) will be described. The additional monomer (a-3) is a monomer other than the (meth)acrylate represented by the formula (a1) and the aromatic vinyl compound (a-2), and examples thereof include compounds copolymerizable with the (meth)acrylate (a-1) and the aromatic vinyl compound (a-2). Specific examples thereof include (meth)acrylic acid, an aromatic (meth)acrylate (preferably one in which a substituted or unsubstituted aromatic ring group has an acryloyloxy group attached thereto), an alkoxy (meth)acrylate, an aryloxy (meth)acrylate, and a non-aromatic vinyl compound. Specific examples include benzyl (meth)acrylate, phenyl (meth)acrylate, methoxyethyl (meth)acrylate, ethoxyethyl (meth)acrylate, 2-naphthyl (meth)acrylate, and phenoxymethyl (meth)acrylate. (Meth)acrylic acid is preferred, and methacrylic acid is more preferred.

The resin composition of the present invention includes the acrylic resin (A) at a proportion of preferably 10 mass % or more, more preferably 20 mass % or more, still more preferably 30 mass % or more, further preferably 40 mass % or more, still further preferably 50 mass % or more, even further preferably 60 mass % or more, particularly further preferably 65 mass % or more. When the proportion is set to the lower limit or more, a resin composition having a higher hardness can be provided. The upper limit of the content of the acrylic resin (A) in the resin composition of the present invention is preferably 90 mass % or less, more preferably 85 mass % or less and may be 80 mass % or less or 75 mass % or less. When the proportion is set to the upper limit or less, a resin composition having a higher refractive index can be provided.

The resin composition of the present invention may include only one type of the acrylic resin (A) or may include two types or more of the acrylic resin (A). When two types or more thereof are included, the total amount preferably falls within the range described above.

### <Random Copolymer (B)>

The resin composition of the present invention includes a random copolymer (B) derived from a monomer composition B composed of 5 to 95 mass % of a (meth)acrylate represented by the formula (b1) (b-1), 5 to 95 mass % of an aromatic (meth)acrylate (b-2), and 0 to 20 mass % of an additional monomer (b-3):

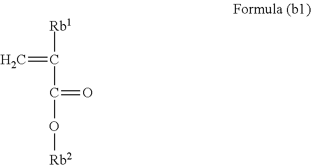

wherein Rb¹ is a hydrogen atom or a methyl group, and Rb² is an aliphatic group.

Incorporation of the random copolymer (B) enables the resulting resin composition to maintain its high hardness and to have a higher refractive index. Additionally, when the random copolymer (B) is employed, the compatibility with the acrylic resin (A) becomes favorable, and a plate-shaped molded article having excellent transparency is provided.

Here, the expression “composed of” with respect to the monomer composition B means that the monomers constituting substantially all the constituent units excluding both ends are the (meth)acrylate represented by the formula (b1) (b-1), the aromatic (meth)acrylate (b-2), or the additional monomer (b-3). The expression “substantially all the constituent units excluding both ends” herein means 99.0 mol % or more, preferably 99.5 mol % or more, more preferably 99.9 mol % or more of all the constituent units excluding both ends.

The content of the (meth)acrylate represented by the formula (b1) (b-1) in the monomer composition B is preferably 10 mass % or more, more preferably 30 mass % or more, still more preferably 40 mass % or more, further preferably 50 mass % or more, still further preferably 65 mass % or more, even further preferably 70 mass % or more, particularly further preferably 75 mass % or more. When the content is set to the lower limit or more, a high pencil hardness tends to be exhibited. The upper limit of the content of the (meth)acrylate represented by the formula (b1) (b-1) is preferably 90 mass % or less, more preferably 85 mass % or less, still more preferably less than 85 mass %, further preferably 82 mass % or less. When the content is set to the upper limit or less, a resin composition having a high refractive index tends to be provided.

The content of the aromatic (meth)acrylate (b-2) in the monomer composition B is preferably 10 mass % or more, more preferably 15 mass % or more, still more preferably more than 15 mass %, further preferably 18 mass % or more. When the content is set to the lower limit or more, a high pencil hardness tends to be exhibited. The upper limit of the content of the aromatic (meth)acrylate (b-2) is preferably 90 mass % or less, more preferably 70 mass % or less, still more preferably 60 mass % or less, further preferably 50 mass % or less, still further preferably 35 mass % or less, even further preferably 30 mass % or less, particularly further preferably 25 mass % or less. When the content is set to the upper limit or less, a resin composition having a high refractive index tends to be provided.

The upper limit of the content of the additional monomer (b-3) in the monomer composition B is preferably 15 mass % or less, more preferably 10 mass % or less, still more preferably 5 mass % or less, further preferably 3 mass % or less, still further preferably 1 mass % or less. When the content is set to the upper limit or less, a high pencil hardness tends to be exhibited.

The monomer composition B may include only one type of each of the (meth)acrylate represented by the formula (b1) (b-1), the aromatic (meth)acrylate (b-2), and the additional monomer (b-3) or may include two types or more of each of them. When two types or more thereof are included, the total amount preferably falls within the range described above.

The weight average molecular weight of the random copolymer (B) is preferably 5,000 or more, more preferably 8,000 or more, still more preferably 10,000 or more. When the weight average molecular weight is set to the lower limit or more, a material having more excellent toughness can be provided. The weight average molecular weight of the random copolymer (B) is also preferably 100,000 or less, more preferably 50,000 or less, still more preferably 30,000 or less, further preferably 20,000 or less. When the weight average molecular weight is set to the upper limit or less, the random copolymer (B) has excellent compatibility with the (meth)acrylate, and a more transparent resin composition can be provided. When two or more random copolymers (B) are included, the weight average molecular weight is regarded as the weight average molecular weight of the mixture.

Next, each of the monomers constituting the monomer composition B will be described.

First, the details of the (meth)acrylate represented by the formula (b1) (b-1) will be described. When the (meth)acrylate represented by the formula (b1) is used, a resin composition exhibiting a high pencil hardness tends to be provided.

In the above formula (b1), Rb¹ is a hydrogen atom or a methyl group, preferably a methyl group. Rb² is an aliphatic group, preferably a linear or branched aliphatic group, more preferably a linear aliphatic group. Examples of the aliphatic group include an alkyl group (including a cycloalkyl group), an alkynyl group (including a cycloalkynyl group), and an alkenyl group (including a cycloalkenyl group). The aliphatic group is preferably an alkyl group, more preferably a linear or branched alkyl group, still more preferably a linear alkyl group. The aliphatic group as Rb² has preferably 1 to 10 carbon atoms, more preferably 1 to 5 carbon atoms, still more preferably 1 to 3 carbon atoms, further preferably 1 or 2 carbon atoms, still further preferably 1 carbon atom.

The (meth)acrylate represented by the formula (b1) is preferably an alkyl (meth)acrylate (preferably alkyl methacrylate), particularly preferably methyl (meth)acrylate (preferably methyl methacrylate).

Next, the details of the aromatic (meth)acrylate (b-2) will be described. When the aromatic (meth)acrylate (b-2) is used, a resin composition having a higher refractive index can be provided.

The aromatic (meth)acrylate (b-2) is a compound having a (meth)acryloyloxy group and an aromatic ring group. The aromatic (meth)acrylate (b-2) preferably includes an aromatic methacrylate.

The aromatic (meth)acrylate (b-2) is preferably a compound represented by acryloyloxy group-L²-Ar². Wherein L² is a single bond or a divalent linking group, preferably a single bond or a divalent linking group having a formula weight of 100 to 500, more preferably a single bond or a divalent linking group having a formula weight of 100 to 300. When L² is a divalent linking group, the group is preferably an aliphatic hydrocarbon group. Ar² is an aromatic ring group, preferably a substituted or unsubstituted benzene ring group or naphthalene ring group (preferably a benzene ring group), still more preferably an unsubstituted benzene ring group.

The aromatic (meth)acrylate (b-2) is also preferably a compound having a molecular weight of 148 to 600.

A first embodiment of the aromatic (meth)acrylate (b-2) in the present invention is a (meth)acrylate represented by the formula (b21). When the (meth)acrylate represented by the formula (b21) is used, a resin composition having a higher refractive index can be provided.

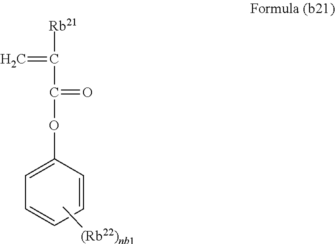

wherein Rb^{2l} is a hydrogen atom or a methyl group, Rb²² is a substituent, and nb1 is an integer of 0 to 6.

In the above formula (b21), Rb²¹ is preferably a methyl group.

In the above formula (b21), Rb²² is a substituent, and examples of the substituent include a halogen atom (preferably a chlorine atom, fluorine atom, or bromine atom), a hydroxy group, an alkyl group (preferably an alkyl group having 1 to 5 carbon atoms), an aryl group (preferably a phenyl group), an alkenyl group (preferably an alkenyl group having 2 to 5 carbon atoms), an alkoxy group (preferably an alkoxy group having 1 to 5 carbon atoms), and an aryloxy group (preferably a phenoxy group). When nb1 is 2 or more, a plurality of Rb²² each may be the same or different.

nb1 is preferably an integer of 5 or less, more preferably an integer of 4 or less, still more preferably an integer of 3 or less, further preferably an integer of 2 or less, still further preferably an integer of 1 or less, even further preferably 0.

A second embodiment of the aromatic (meth)acrylate (b-2) in the present invention is a (meth)acrylate represented by the formula (b22). When the (meth)acrylate represented by the formula (b22) is used, a resin composition having a higher refractive index can be provided.

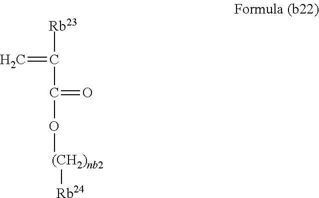

wherein Rb²³ is a hydrogen atom or a methyl group, Rb²⁴ is an aromatic ring-containing group, and nb2 is an integer of 1 to 4.

In the above formula (b22), Rb²³ is preferably a methyl group.

In the above formula (b22), Rb²⁴ is an aromatic ring-containing group, more preferably a group containing one or two or more benzene rings. R²⁴ may also have a substituent. In the present invention, the aromatic ring contained in Rb²⁴ is preferably directly bonded to the (CH₂)_{nb2} group of the formula (b22).

Examples of the substituent include a halogen atom (preferably a chlorine atom, fluorine atom, or bromine atom), a hydroxy group, an alkyl group (preferably an alkyl group having 1 to 5 carbon atoms), an aryl group (preferably a phenyl group), an alkenyl group (preferably an alkenyl group having 2 to 5 carbon atoms), an alkoxy group (preferably an alkoxy group having 1 to 5 carbon atoms), and an aryloxy group (preferably a phenoxy group).

In the above formula (b22), nb2 is preferably an integer of 1 to 3, more preferably 1 or 2, still more preferably 1.

The (meth)acrylate represented by the formula (b22) is preferably a (meth)acrylate represented by the formula (b23).

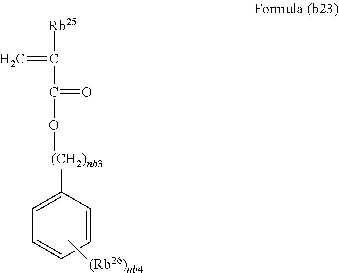

wherein Rb²⁵ is a hydrogen atom or a methyl group, nb3 is an integer of 1 to 4, Rb²⁶ is a substituent, at least one of Rb²⁶ is an aryl group, and nb4 is an integer of 1 to 6.

In the formula (b23), Rb²⁵ is preferably a methyl group. In the formula (b23), Rb²⁶ is a substituent, and examples of the substituent include a halogen atom (preferably a chlorine atom, fluorine atom, or bromine atom), a hydroxy group, an alkyl group (preferably an alkyl group having 1 to 5 carbon atoms), an aryl group (preferably a phenyl group), an alkenyl group (preferably an alkenyl group having 2 to 5 carbon atoms), an alkoxy group (preferably an alkoxy group having 1 to 5 carbon atoms), and an aryloxy group (preferably a phenoxy group). When nb4 is 2 or more, a plurality of Rb² each may be the same or different.

At least one of Rb²⁶ is an aryl group, and one of Rb²⁶ is preferably an aryl group. The aryl group is preferably a substituted or unsubstituted phenyl group, more preferably an unsubstituted phenyl group.

In the formula (b23), nb3 is an integer of 1 to 4, preferably an integer of 1 to 3, more preferably 1 or 2, still more preferably 1.

In the formula (b23), nb4 is an integer of 1 to 6, preferably an integer of 1 to 3, more preferably 1 or 2, still more preferably 1.

Specifically, examples of the aromatic (meth)acrylate (b-2) include the following compounds.

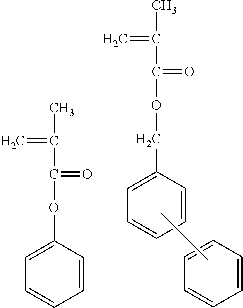

Next, the details of the additional monomer (b-3) in the monomer composition B will be described.

As the additional monomer (b-3), monomers known as raw material monomers for the acrylic resin, other than the (meth)acrylate represented by the formula (b1) (b-1) and aromatic (meth)acrylate (b-2), may be broadly employed. Specifically, examples thereof include (meth)acrylates other than the (meth)acrylate represented by the formula (b1) (b-1) and the aromatic (meth)acrylate (b-2) and vinyl compounds, and (meth)acrylates other than the (meth)acrylate represented by the formula (b1) (b-1) and the aromatic (meth)acrylate (b-2) are preferred.

Example of (meth)acrylates other than the (meth)acrylate represented by the formula (b1) (b-1) and the aromatic (meth)acrylate (b-2) include (meth)acrylic acid, an alkoxy (meth)acrylate, and an aryloxy (meth)acrylate. (Meth)acrylic acid is preferred, and methacrylic acid is more preferred.

The resin composition of the present invention includes the random copolymer (B) at a proportion of 1 part by mass or more, preferably 5 parts by mass or more, more preferably 10 parts by mass or more, still more preferably 15 parts by mass or more, with respect to 10 to 99 parts by mass of the acrylic resin (A). When the proportion is set to the lower limit or more, the refractive index is expected to further increase. The resin composition of the present invention also includes the random copolymer (B) at a proportion of 90 parts by mass or less, preferably includes at a proportion of 80 parts by mass or less, more preferably includes at a proportion of 70 parts by mass or less, still more preferably includes at a proportion of 60 parts by mass or less, further preferably includes at a proportion of 50 parts by mass or less, still further preferably includes at a proportion of 40 parts by mass or less, and may include the random copolymer (B) at a proportion of 35 parts by mass or less, with respect to 10 to 99 parts by mass of the acrylic resin (A). When the proportion is set to the upper limit or less, the toughness of the material is unlikely to decrease, and molding is more easily achieved.

The resin composition of the present invention may include one type of the random copolymer (B) or may include two or more types thereof. When two types or more thereof are included, the total amount preferably falls within the range described above.

In the present invention, the amount of the above acrylic resin (A) and the random copolymer (B) preferably corresponds to 90 mass % or more, more preferably corresponds to 95 mass % or more thereof, still more preferably corresponds to 98 mass % or more thereof, further preferably corresponds to 99 mass % or more, of the resin components contained in the resin composition. The upper limit may be 100 mass % of the resin components.

In the present invention, the amount of the above acrylic resin (A) and random copolymer (B) preferably corresponds to 90 mass % or more, more preferably corresponds to 94 mass % or more, still more preferably corresponds to 97 mass % or more, of the resin composition. The upper limit may correspond to 99.9 mass % of the resin components.

### <Antioxidant (D)>

The resin composition of the present invention preferably contains an antioxidant (D).

Examples of the antioxidant (D) include a phenol-based antioxidant, an amine-based antioxidant, a phosphorus-based antioxidant, and a thioether-based antioxidant. Of these, in the present invention, a phosphorus-based antioxidant and a phenol-based antioxidant (more preferably a hindered phenol-based antioxidant) are preferred. A phosphorus-based antioxidant is particularly preferred for giving excellent hue to a molded article.

As a phosphorus-based antioxidant, a phosphite-based antioxidant is preferred, and a phosphite compound represented by the following formula (1) or (2) is preferred.

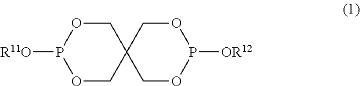

Wherein, in the formula (1), R¹¹ and R¹², each independently represent an alkyl group having 1 to 30 carbon atoms or an aryl group having 6 to 30 carbon atoms; and

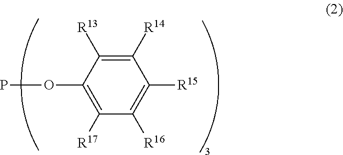

Wherein, in the formula (2), R¹³ to R¹⁷ each independently represent a hydrogen atom, an aryl group having 6 to 20 carbon atoms, or an alkyl group having 1 to 20 carbon atoms.

In the above formula (1), the alkyl groups represented by R¹¹ and R¹² are preferably each independently a linear or branched alkyl group having 1 to 10 carbon atoms. When R¹¹ and R¹² each are an aryl group, an aryl group represented by any of the following formula (1-a), (1-b), or (1-c) is preferred. * in the formula represents a bonding site.

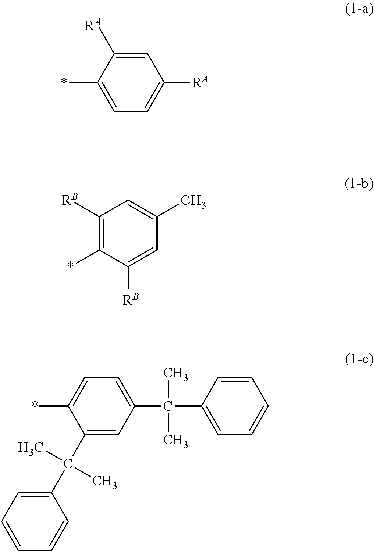

wherein, in the formula (1-a), R^{A} each independently represent an alkyl group having 1 to 10 carbon atoms; and in the formula (1-b), RB each independently represent an alkyl group having 1 to 10 carbon atoms.

With respect to the hindered phenol-based antioxidant, the description in the paragraph 0063 of Japanese Patent Laid-Open No. 2018-090677 and the description in the paragraph 0076 of Japanese Patent Laid-Open No. 2018-188496 can be referred to, and the contents thereof are incorporated herein.

With respect to the antioxidant (D), in addition to the above descriptions, the description in the paragraphs 0057 to 0061 of Japanese Patent Laid-Open No. 2017-031313 can be referred to, and the contents thereof are incorporated herein.

The content of the antioxidant (D) is preferably 0.001 parts by mass or more, more preferably 0.008 parts by mass or more, based on 100 parts by mass of the resin composition. The upper limit of the content of the antioxidant (D) is preferably 0.5 parts by mass or less, more preferably 0.3 parts by mass or less, still more preferably 0.2 parts by mass or less, further preferably 0.15 parts by mass or less, even further preferably 0.10 parts by mass or less, particularly further preferably 0.08 parts by mass or less, based on 100 parts by mass of the resin components.

When the content of the antioxidant (D) is set to the above lower limit or more, a molded article having a more favorable hue and thermal discoloration resistance can be provided.

Additionally, when the content of the antioxidant (D) is set to the above upper limit or less, a molded article having favorable stability in heat and humidity can be provided without deterioration of thermal discoloration resistance.

The antioxidant (D) may be used singly or in combination of two or more. When two types or more thereof are used, the total amount preferably falls within the range described above.

### <Mold Release Agent (E)>

The resin composition of the present invention preferably includes a mold release agent (E).

Incorporation of the mold release agent enables a take-up property to be improved when a molded article in a film shape or sheet shape (plate-shaped molded article) is taken up.

The type of the mold release agent (E) is not particularly specified, and examples thereof include an aliphatic carboxylic acid, an ester of an aliphatic carboxylic acid and alcohol, an aliphatic hydrocarbon compound having a number average molecular weight of 200 to 15,000, a polyether having a number average molecular weight of 100 to 5,000, and polysiloxane-based silicone oil.

With respect to the details of the mold release agent, the description in the paragraphs 0035 to 0039 of International Publication No. WO 2015/190162 can be referred to, and the contents thereof are incorporated herein.

The content of the mold release agent (E) is preferably 0.001 parts by mass or more, more preferably 0.005 parts by mass or more, still more preferably 0.01 parts by mass or more, based on 100 parts by mass of the resin composition. The upper limit is preferably 0.5 parts by mass or less, more preferably 0.3 parts by mass or less, still more preferably 0.2 parts by mass or less.

The mold release agent (E) may be used only singly or in combination of two or more. When two types or more thereof are used, the total amount preferably falls within the range described above.

### <Additional Components>

The resin composition of the present invention may include, in addition to the above components, a thermoplastic resin other than those described above, an ultraviolet absorbent, a heat stabilizer, a flame retardant, a flame-retardant aid, a colorant, an antistatic agent, a fluorescent whitening agent, an antifog agent, a fluidity improver, a plasticizer, a dispersant, an antimicrobial agent, an anti-blocking agent, an impact modifier, a slidability improver, a hue improver, and an acid trap agent. These components may be used singly or in combination of two or more.

The content of the above components, if contained, is preferably 0.1 to 5 mass % in total with respect to the resin composition.

### <Applications>

The resin composition of the present invention can be molded into, for example, a plate shape for use. In other words, the present invention relates to a plate-shaped molded article formed from the resin composition of the present invention.

Examples of the plate-shaped molded article include a plate, a film, and a sheet. The plate-shaped molded article may be a single molded article or may be a portion of a laminate laminated on a different base material. The lower limit of the thickness of the plate-shaped molded article is preferably 5 μm or more, more preferably 10 μm or more, still more preferably 20 μm or more, and may be 100 μm or more. When the thickness is set to the lower limit or more, molding becomes easier and additionally, the hardness of the molded article tends to increase. The upper limit of the thickness of the plate-shaped molded article is not particularly limited, but a thickness of 10,000 μm or less is practical.

The plate-shaped molded article of the present invention is molded by injection-molding, extrusion with use of a T-die, or the like.

The total light transmittance of the plate-shaped molded article of the present invention is preferably 90.0% or more, more preferably 91.0% or more. The upper limit of the total light transmittance is ideally 100%, but is practically 95.0% or less.

The total light transmittance is measured in accordance with the description of Examples described below.

The refractive index of the plate-shaped molded article of the present invention is, for example, preferably 1.495 or more, more preferably 1.500 or more, still more preferably 1.502 or more. The upper limit is, for example, preferably 1.560 or less, more preferably 1.540 or less, still more preferably, 1.530 or less.

When the refractive index is set to the lower limit or more, for example, the difference in the refractive index between the molded article and the polycarbonate resin base material can be made smaller, and iridescent irregularities can be effectively suppressed.

The refractive index is measured in accordance with the description of Examples described below.

The pencil hardness of the plate-shaped molded article of the present invention is preferably F or higher, preferably H or higher. The upper limit of the pencil hardness is, for example, 3H. Even when the pencil hardness is 2H or lower, necessary required performance is satisfied.

The pencil hardness is measured in accordance with the description of Examples described below.

Further, the multilayered article of the present invention preferably has a hard coat layer on the plate-shaped molded article and/or the base material, more preferably has a hard coat layer on the plate-shaped molded article. Further, the multilayered article of the present invention also preferably has a low refractive index layer on the surface of the hard coat layer, which surface is opposite to the base material. In other words, the above multilayered article can be used as an anti-reflection film.

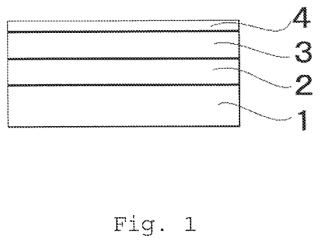

FIG. 1 is a schematic view illustrating an exemplary anti-reflection film, in which 1 denotes the base material, 2 denotes the plate-shaped molded article, 3 denotes the hard coat layer, and 4 denotes the anti-reflection layer. In FIG. 1, the base material 1, the plate-shaped molded article 2, the hard coat layer 3, and the anti-reflection layer 4 are laminated in the order mentioned, but other layers may be included without departing from the subject matter of the present invention. Alternatively, the hard coat layer may be provided on the side of the base material 1.

Next, the base material 1 will be described.

The type of the base material 1 is not particularly specified. Any known base material may be employed as long as the performance required for the multilayered article of the present invention is satisfied. Specifically, a resin base material is preferred. Specific examples thereof include a polyolefin resin, a polyester resin, a polycarbonate resin, an acrylic resin, and a polystyrene resin, and a polycarbonate resin is preferably included. These may be used singly or may constitute a composite base material in combination of two or more.

The polycarbonate resin is preferably an aromatic polycarbonate resin, more preferably a bisphenol A polycarbonate resin. The bisphenol A polycarbonate resin refers to a resin having a carbonate constituent unit derived from bisphenol A and a derivative thereof and preferably has the constituent unit represented by the following formula (B-1). * in the formula represents a bonding site.

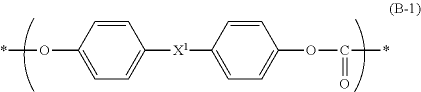

In the formula (B-1), X¹ represents the following structure.

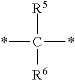

R⁵ and R⁶ each are an alkyl group or a hydrogen atom, at least one of R⁵ and R⁶ is preferably a methyl group, and both of them are more preferably methyl groups.

The formula (B-1) is preferably represented by the following formula (B-2).

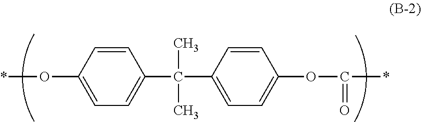

The content of the constituent unit represented by the formula (B-1) in the bisphenol A polycarbonate resin is preferably 70 mol % or more, more preferably 80 mol % or more, still more preferably 90 mol % or more, in the total constituent units excluding both ends. The upper limit is not particularly limited, and the content of the constituent unit represented by the formula (B-1) may be 100 mol %. A particularly preferred example of the bisphenol A polycarbonate includes a resin in which substantially all the constituent units excluding both ends are constituted by the constituent unit of the formula (B-1). All the constituent units substantially excluding both ends herein means 99.0 mol % or more, preferably 99.5 mol % or more, more preferably 99.9 mol % or more of all the constituent units excluding both ends.

The bisphenol A polycarbonate resin may have a constituent unit other than the carbonate constituent unit derived from bisphenol A and a derivative thereof. An example of a dihydroxy compound constituting the other constituent unit may include the aromatic dihydroxy compound described in the paragraph 0014 of Japanese Patent Laid-Open No. 2018-154819, and the contents thereof are incorporated herein.

Examples of the end structure of the bisphenol A polycarbonate resin include an alkyl group-substituted phenoxy group and an alkoxycarbonyl phenoxy group.

The alkyl group in the alkyl group-substituted phenoxy group has preferably 1 to 10 carbon atoms, more preferably 1 to 8 carbon atoms, still more preferably 2 to 5 carbon atoms. Examples of the alkyl group-substituted phenoxy group include a m-methylphenoxy group, a p-methylphenoxy group, a m-propylphenoxy group, a p-propylphenoxy group, and a p-tert-butylphenoxy group.

The alkoxy group in the alkoxycarbonyl phenoxy group has preferably 1 to 20 carbon atoms. The alkoxycarbonyl phenoxy group is preferably an alkoxycarbonyl phenoxy group having 1 to 10 carbon atoms, more preferably a p-tert-butylphenoxy group, from the viewpoint of heat resistance. For hot bending applications, an alkoxycarbonyl phenoxy group having 11 to 20 carbon atoms is preferred. A p-hexadecyloxycarbonyl phenoxy group is more preferred from the viewpoint of hot bending temperatures.

The content of the polycarbonate resin (preferably a bisphenol A polycarbonate resin) included in the base material 1 is preferably 80 mass % or more, more preferably 90 mass % or more, still more preferably 95 mass % or more, based on the total mass of the base material 1, from the viewpoint of heat resistance and mechanical characteristics.

The base material 1, if necessary, may contain a resin other than the polycarbonate resin and various resin additives as long as the desired properties are not significantly impaired.

Examples of the resin other than the polycarbonate resin include a polyester resin, a polystyrene resin, an acrylic resin, a polyether resin, and a polyimide resin.

Examples of the resin additives include an antioxidant, a mold release agent, a flame retardant, an anti-drip agent, a dye and a pigment (including carbon black), an antistatic agent, an antifog agent, an anti-blocking agent, a fluidity improver, a plasticizer, a dispersant, and an antimicrobial agent. The resin additives may be contained singly, or two or more thereof may be contained in any combination and proportion.

A method for producing the bisphenol A polycarbonate resin is not particularly limited, and any method may be employed. Examples thereof can include an interfacial polymerization method, a melt transesterification method, a pyridine method, a ring-opening polymerization method for a cyclic polycarbonate compound, and a solid-phase transesterification method for a prepolymer.

Additionally, with respect to the details of the polycarbonate resin, the description in the paragraphs 0040 to 0073 of Japanese Patent Laid-Open No. 2019-035001 and the description in the paragraphs 0016 to 0043 of Japanese Patent Laid-Open No. 2018-103518 can be referred to, and the contents thereof are incorporated herein.

The base material 1 may be a single layer or a multilayer.

The thickness of the base material 1 is not particularly limited and is preferably 30 μm or more, more preferably 35 μm or more, still more preferably 40 μm or more, further preferably 50 μm or more. The thickness of base material 1 is also preferably 10,000 μm or less, more preferably 5,000 μm or less and may be 3,000 μm or less.

The refractive index of the base material 1 is, for example, preferably 1.610 or less, more preferably 1.600 or less. The base material 1 having a lower limit of the refractive index of 1.500 or more, further 1.510 or more, particularly 1.520 or more, for example, also may be used.

In the present invention, the difference in refractive index between the base material 1 and the plate-shaped molded article 2 is preferably 0.050 or less. When the difference in refractive index is set to such a value, iridescent irregularities can be suppressed more effectively. The lower limit of the difference in refractive index is ideally 0, but even when the lower limit is 0.010 or more, further 0.030 or more, for example, the required performance is sufficiently satisfied.

Next, the hard coat layer 3 will be described.

The hard coat layer 3 is provided mainly for the purpose of improving abrasion resistance.

The hard coat layer preferably exhibits a hardness of “H” or higher in the pencil hardness test specified by JIS K5600-5-4:1999.

The type of the hard coat layer 3 is not particularly specified. The hard coat layer 3 is preferably formed by hard coat treatment to be applied onto the surface of the plate-shaped molded article 2. Specifically, the hard coat layer 3 is preferably laminated by applying a hard coat material curable by heat curing or active energy rays and then curing the applied hard coat material.

Examples of a paint to be cured by use of active energy rays include a resin composition composed of one or a plurality of monofunctional or polyfunctional (meth)acrylate monomers or oligomers, more preferably a resin composition including a urethane (meth)acrylate oligomer. To these resin compositions, a photopolymerization initiator is preferably added as a curing catalyst.

With respect to the hard coat layer 3, the description in the paragraphs 0045 to 0055 of Japanese Patent Laid-Open No. 2013-020130, the description in the paragraphs 0073 to 0076 of Japanese Patent Laid-Open No. 2018-103518, and the description in the paragraphs 0062 to 0082 of Japanese Patent Laid-Open No. 2017-213771 can be referred to, and the contents thereof are incorporated herein.

Examples of a thermosetting-type resin paint include a polyorganosiloxane-based resin paint and a crosslinking-type acrylic-based resin paint. Some of these resin compositions are commercially available as acrylic resins or hard coat agents for polycarbonate. Such a resin composition may be selected as appropriate in consideration of suitability with the painting line.

The hard coat layer 3 may be a single layer or a multilayer.

The thickness of the hard coat layer 3 is not particularly limited, and is preferably 1 to 10 μm, more preferably 2 to 8 μm, still more preferably 3 to 7 μm.

The refractive index of the hard coat layer 3 is, for example, preferably less than 1.550, more preferably 1.545 or less. The lower limit is preferably 1.450 or more, more preferably 1.470 or more, still more preferably, particularly 1.490 or more.

In the present invention, the difference in refractive index between the hard coat layer 3 and the plate-shaped molded article 2 is preferably 0.050 or less. When the difference in refractive index is set to such a value, iridescent irregularities can be suppressed more effectively. The lower limit of the difference in refractive index is ideally 0, but even when the lower limit is, for example, 0.010 or more, further 0.030 or more, the required performance is sufficiently satisfied.

Next, the anti-reflection layer 4 will be described.

Examples of the anti-reflection layer 4 include a single layer of a low refractive index (only a low refractive index layer) and a multilayer including a low refractive index layer and a high refractive index layer alternately laminated. A laminate obtained by laminating the anti-reflection layer 4 on a multilayered article can be used as an anti-reflection film. For presenting an anti-reflection function, the low refractive index layer is preferably disposed on the outermost side of the anti-reflection layer 4.

The type of the low refractive index layer is not particularly specified. A preferred example of the low refractive index layer includes one formed by curing and polymerizing a resin material including fluorine-containing urethane acrylate and (meth)acrylate.

The low refractive index layer may also include a member for lowering the refractive index. The member for lowering the refractive index is preferably silica, metal fluoride particulates, or the like, particularly preferably hollow silica.

The low refractive index layer has a refractive index usually lower than that of each of the adjacent base material, the plate-shaped molded article, the hard coat layer, and the high refractive index layer. The refractive index of the low refractive index layer is preferably 1.31 to 1.40, more preferably 1.32 to 1.39.

The type of the high refractive index layer is not particularly specified. A preferred example thereof includes one formed by curing and polymerizing a resin material including a mixture of urethane (meth)acrylate obtained by dehydration condensation reaction using three components: fluorene-based diol, isocyanate, and (meth)acrylate, and (meth)acrylate. The high refractive index layer may also include a member for enhancing the refractive index. The member for enhancing the refractive index is preferably a metal oxide such as titanium oxide and zirconium oxide, particularly preferably zirconium oxide.

The high refractive index layer has a refractive index higher than that of each of the adjacent base material (layer), the plate-shaped molded article (layer), the hard coat layer, and the low refractive index layer. The refractive index of the high refractive index layer is preferably 1.68 to 1.75, more preferably 1.69 to 1.74.

The multilayered article of the present invention may have other layers in addition to those described above. Specific examples thereof include an adhesion layer, a pressure-sensitive adhesion layer, and an anti-fouling layer.

Additionally, the surface of the multilayered article may be subjected to any one or more of anti-fingerprint treatment, anti-glare treatment, weather resistant treatment, antistatic treatment, anti-fouling treatment, and anti-blocking treatment. The anti-blocking treatment refers to a treatment that allows films to be easily released from each other even if the films adhere to each other, and examples thereof include adding an anti-blocking agent and providing asperities on the surface of the multilayered article.

The multilayered article of the present invention can be formed by melting each of resins to be used under conditions for the resin, introducing each of the melted resins into an extrusion die, and laminating the resins in the die followed by molding the laminated resins into a sheet shape or molding each of the resins into a sheet shape and then laminating the sheets, by use of a main extruder that extrudes the base material such as a polycarbonate resin and a sub extruder that extrudes the resin composition of the present invention.

The multilayered article of the present invention can be suitably used in optical components, design products, anti-reflection films, and the like.

The multilayered article of the present invention is suitably used in display apparatuses, electrical/electronic apparatuses, OA apparatuses, portable electronic devices, machine components, consumer electronic apparatuses, vehicle components, various containers, components and the like of lighting apparatuses, and the like. Of these, the multilayered article is suitably used particularly in housings of various displays, electrical/electronic apparatuses, QA apparatuses, portable electronic devices, and consumer electronic apparatuses, lighting apparatuses and vehicle components (particularly vehicle interior components), surface layer films of smartphones or touch panels, optical materials, and optical disks. Particularly, the molded article of the present invention is preferably used as a film for sensors of touch panels or an anti-reflection film for various displays.

### EXAMPLES

The present invention will be further specifically described with reference to the following Examples. The materials, amounts used, proportions, processing tasks and procedures, and the like shown in the following Examples may be changed as appropriate without departing from the subject matter of the present invention. Accordingly, the scope of the present invention is not limited to the specific examples shown below.

### [Raw Materials]

### •Acrylic Resin (A)

(A1) Methyl methacrylate polymer (methyl methacrylate/methyl acrylate=97 mass %/3 mass %, manufactured by Arkema S.A., V020, weight average molecular weight: 130,000)

(A2) Methyl methacrylate/methacrylic acid random copolymer (methyl methacrylate/methacrylic acid=95 mass %/5 mass %, manufactured by Arkema S.A., HT121, weight average molecular weight: 76,000)

(A3) Methyl methacrylate/styrene random copolymer (manufactured by Toyo Styrene Co., Ltd., methyl methacrylate/styrene=75 mass %/25 mass %, MS-750, weight average molecular weight: 150,000)

### •Random Copolymer (B)

(B1) Methyl methacrylate/phenyl methacrylate random copolymer (methyl methacrylate/phenyl methacrylate=80 mass %/20 mass %, manufactured by Mitsubishi Chemical Corporation, H-880, weight average molecular weight: 15,000)

(B2) Methyl methacrylate/p-phenylbenzyl methacrylate random copolymer (methyl methacrylate/p-phenylbenzyl methacrylate=80 mass %/20 mass %, manufactured by Mitsubishi Gas Chemical Company, Inc., BP2010R, weight average molecular weight: 11,000)

### •Another Polymer (C)

(C1) Methyl methacrylate/styrene random copolymer (methyl methacrylate/styrene=30 mass %/70 mass %, manufactured by Toyo Styrene Co., Ltd., MS-300, weight average molecular weight: 190,000)

### •Antioxidant (D)

(D) Bis (2,6-di-t-butyl-4-methylphenyl) pentaerythritol diphosphite (manufactured by ADEKA Corporation, PEP-36)

### •Mold Release Agent (E)

(E) Glycerin monostearate (manufactured by RIKEN VITAMIN Co., Ltd., RIKEMAL S-100A)

### [Calculation of Compositional Ratio of Copolymer]

As for the compositional ratio of the copolymer (acrylic resin (A), random copolymer (B), additional polymer (C)), a sample was dissolved in deuterated chloroform, and the molar ratio was determined by 1H-NMR or ¹³C-NMR to calculate mass ratio.

### [Method for Measuring Weight Average Molecular Weight]

The weight average molecular weight of each of the acrylic resin (A), the random copolymer (B), and the additional polymer (C) was measured by gel permeation chromatography. The weight average molecular weight was measured specifically as follows.

An LC-20AD system (manufactured by Shimadzu Corporation) was used as the gel permeation chromatography apparatus, and LF-804 (manufactured by Shodex) as the column was connected thereto for use. The column temperature was set to 40° C. The detector used was RID-10A (manufactured by Shimadzu Corporation) as a RI detector. Chloroform was used as the eluent, and the calibration curve was created using standard polystyrene manufactured by TOSOH CORPORATION.

In the case where the above gel permeation chromatography apparatus, column, and detector are difficult to obtain, other apparatuses having equivalent performance are used for the measurement (hereinafter, the same applies to other measurement methods).

### Examples 1 to 6, Comparative Examples 1 to 4

### [Production of Resin Pellets]

Each of the components described above was weighed in the amount to be added described in Table 1 (the amount added is given as a mass ratio). Thereafter, the components were mixed in a tumbler for 15 minutes and then melt-kneaded in a vented twin screw extruder having a screw diameter of 32 mm (“TEX304)” manufactured by The Japan Steel Works, Ltd.) at a cylinder temperature of 270° C. to provide pellets by strand-cutting. It should be noted that, in Comparative Example 4, extrusion could not be achieved, and thus pellets could not be provided.

### [Production of Plate-Shaped Molded Article]

The pellets provided was dried with a hot air-circulation-type dryer at 120° C. for 4 to 7 hours. Then, the dried pellets were molded into a plate-shaped specimen (100×100×3 mm) with an injection-molding machine under conditions including a cylinder temperature of 240° C., a mold temperature of 40° C., and a molding cycle of 55 seconds.

### [Measurement of Total Light Transmittance]

The total light transmittance (%) of the plate-shaped specimen provided above was measured using a haze mater under conditions including D65 light source and 10° field of view.

The injection-molding machine used was “PE100” manufactured by Sodick Co., Ltd. The haze meter used was “HM-150” manufactured by Murakami Color Research Laboratory.

### [Measurement of Refractive Index]

The refractive index of the plate-shaped specimen provided above was determined using an automatic thin film measuring apparatus with a light having a wavelength of 589 nm.

On measurement of the refractive index, a spectroscopic Ellipsometer Auto SE (manufactured by HORIBA, Ltd.) was used as the automatic thin film measuring apparatus.

It should be noted that, in Comparative Example 3, the plate-shaped specimen was opaque and thus the refractive index was not measured.

### [Measurement of Pencil Hardness]

The pencil hardness of the plate-shaped specimen provided above was measured under a 750 g load in compliance with JIS K5600-5-4:1999 using a pencil hardness tester.

TABLE 1

| | | Example | | | | | | Comparative Example | | | |
|---|---|---|---|---|---|---|---|---|---|---|---|
| Component | Abbreviation | 1 | 2 | 3 | 4 | 5 | 6 | 1 | 2 | 3 | 4 |
| Acrylic | A1 | 80 | 70 | | | | 80 | 100 | | | |
| resin (A) | A2 | | | 80 | 70 | | | | | 70 | |
| | A3 | | | | | 70 | | | 100 | 30 | 80 |
| Random | B1 | 20 | 30 | 20 | 30 | 30 | | | | | |
| copolymer (B) | B2 | | | | | | 20 | | | | |
| Additional | C1 | | | | | | | | | | 20 |
| polymer (C) | | | | | | | | | | | |
| Antioxidant (D) | D | 0.01 | 0.02 | 0.01 | 0.01 | 0.01 | 0.01 | 0.01 | 0.01 | 0.01 | 0.01 |
| Mold release | E | 0.04 | 0.06 | 0.04 | 0.04 | 0.04 | 0.04 | 0.04 | 0.04 | 0.04 | 0.04 |
| agent (E) | | | | | | | | | | | |

| | | | | | | | | | | |
|---|---|---|---|---|---|---|---|---|---|---|
| Total light | 92.3 | 92.3 | 92.2 | 92.2 | 91.8 | 91.8 | 92.1 | 91.1 | 43.1 | Not |
| transmittance (%) | | | | | | | | | | producible |
| Refractive index | 1.501 | 1.507 | 1.502 | 1.506 | 1.527 | 1.504 | 1.491 | 1.522 | — | |
| Pencil hardness | H | H | H | H | H | H | 2H | F | H | |

The figure for each of the components in Table 1 is given as a mass ratio.

### REFERENCE SIGNS LIST

1 Base material
2 Plate-shaped molded article
3 Hard coat layer
4 Anti-reflection layer

1. A resin composition comprising:
10 to 99 parts by mass of an acrylic resin (A); and
90 to 1 part by mass of a random copolymer (B) derived from a monomer composition B composed of 5 to 95 mass % of a (meth)acrylate represented by the formula (b1) (b-1), 5 to 95 mass % of an aromatic (meth)acrylate (b-2), and 0 to 20 mass % of an additional monomer (b-3): 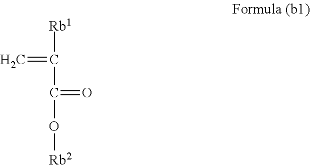
wherein Rb¹ is a hydrogen atom or a methyl group, and Rb² is an aliphatic group.

2. The resin composition according to claim 1, wherein the acrylic resin (A) comprises an acrylic resin derived from a monomer composition A1 composed of more than 90 mass % of a (meth)acrylate represented by the formula (at) (a-1) and 0 mass % or more and less than 10 mass % of an additional monomer (a-11): 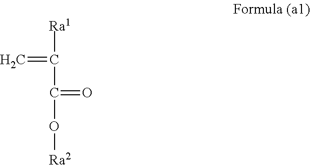
wherein Ra¹ is a hydrogen atom or a methyl group, and Ra² is an aliphatic group.

3. The resin composition according to claim 1, wherein the acrylic resin (A) comprises an acrylic resin derived from a monomer composition A2 composed of 5 to 95 mass % of a (meth)acrylate represented by the formula (a1) (a-1), 5 to 95 mass % of an aromatic vinyl compound (a-2), and 0 to 20 mass % of an additional monomer (a-3): 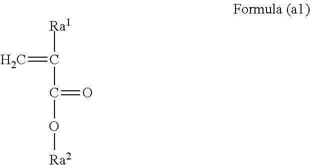
wherein Ra¹ is a hydrogen atom or a methyl group, and Ra² is an aliphatic group.

4. The resin composition according to claim 1, wherein the (meth)acrylate represented by the formula (b1) (b-1) comprises an alkyl methacrylate.

5. The resin composition according to claim 1, wherein the aromatic (meth)acrylate (b-2) comprises an aromatic methacrylate.

6. The resin composition according to claim 1, wherein the aromatic (meth)acrylate (b-2) comprises a (meth)acrylate represented by the formula (b21): 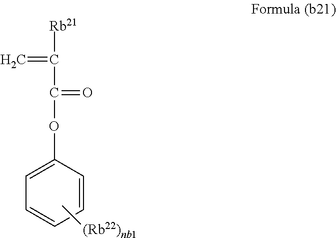
wherein Rb²¹ is a hydrogen atom or a methyl group, Rb²² is a substituent, and nb1 is an integer of 0 to 6.

7. The resin composition according to claim 1, wherein the aromatic (meth)acrylate (b-2) comprises a (meth)acrylate represented by the formula (b22): 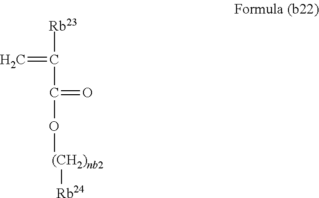
wherein Rb²³ is a hydrogen atom or a methyl group, Rb²⁴ is an aromatic ring-containing group, and nb2 is an integer of 1 to 4.

8. The resin composition according to claim 1, wherein the aromatic (meth)acrylate (b-2) comprises a (meth)acrylate represented by the formula (b23): 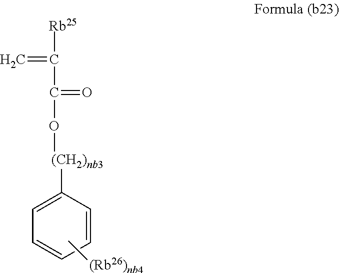
wherein Rb²⁵ is a hydrogen atom or a methyl group, nb3 is an integer of 1 to 4, Rb²⁶ is a substituent, at least one of Rb²⁶ is an aryl group, and nb4 is an integer of 1 to 6.

9. The resin composition according to claim 1, wherein a proportion of the (meth)acrylate represented by the formula (b1) (b-1) in the monomer composition B is 40 mass % or more and less than 85 mass %.

10. The resin composition according to claim 9, wherein the acrylic resin (A) comprises an acrylic resin derived from a monomer composition A1 composed of more than 90 mass % of a (meth)acrylate represented by the formula (a1) (a-1) and 0 mass % or more and less than 10 mass % of an additional monomer (a-11): 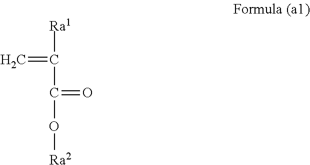
wherein Ra¹ is a hydrogen atom or a methyl group, and Ra² is an aliphatic group.

11. The resin composition according to claim 9, wherein the acrylic resin (A) comprises an acrylic resin derived from a monomer composition A2 composed of 5 to 95 mass % of a (meth)acrylate represented by the formula (a1) (a-1), 15 to 95 mass % of an aromatic vinyl compound (a-2), and 0 to 20 mass % of an additional monomer (a-3).

12. The resin composition according to claim 1, wherein the acrylic resin (A) comprises an acrylic resin derived from a monomer composition A3 composed of methyl methacrylate at a proportion of 95 mass % or more.

13. The resin composition according to claim 1, wherein the acrylic resin (A) comprises a random copolymer derived from a monomer composition A4 composed of methyl methacrylate and methacrylic acid.

14. The resin composition according to claim 1, further comprising 0.001 to 0.5 parts by mass of an antioxidant (D) based on 100 parts by mass of the resin composition.

15. The resin composition according to claim 1, further comprising 0.001 to 0.5 parts by mass of a mold release agent (E) based on 100 parts by mass of the resin composition.

16. A plate-shaped molded article formed from the resin composition according to claim 1.

17. The plate-shaped molded article according to claim 16, having a thickness of 5 to 10,000 μm.

18. A multilayered article comprising a base material and the plate-shaped molded article according to claim 16.

19. The multilayered article according to claim 18, wherein the base material comprises a polycarbonate resin.

20. The multilayered article according to claim 18, further comprising a hard coat layer on the plate-shaped molded article and/or the base material.

21. The multilayered article according to claim 20, further comprising an anti-reflection layer on the hard coat layer.

22. The multilayered article according to any ene of claim 18, wherein any one or more of anti-fingerprint treatment, anti-glare treatment, weather resistant treatment, antistatic treatment, anti-fouling treatment, and anti-blocking treatment are further applied on at least one surface of the multilayered article.

23. An anti-reflection film comprising the multilayered article according to claim 18.
